(19) United States
(12) Patent Application Publication
(10) Pub. No.: US 2006/0261594 A1
(43) Pub. Date: Nov. 23, 2006

(54) Motor vehicle exhaust line member

(75) Inventor: Michel Gerard, Hericourt (FR)

Correspondence Address: YOUNG & THOMPSON, 745 SOUTH 23RD STREET, 2ND FLOOR, ARLINGTON, VA, 22202, US

(73) Assignee: FAURECIA SYSTEMS D'ECHAPPEMENT, Nanterre (FR)

(21) Appl. No.: 10/554,500

(22) PCT Filed: Apr. 29, 2004
(86) PCT No.: PCT/FR04/01042

§ 371 Date: Oct. 26, 2005

(30) Foreign Application Priority Data
Apr. 29, 2003 (FR) 0305276

(51) Int. Cl. F16L 25/00

(52) U.S. Cl. 285/331

(57) ABSTRACT

An exhaust line member includes an exhaust line element (20) including a wall delimiting a gas circulation orifice (38), a gas circulation pipe (28) nested in the orifice and secured to the periphery of the orifice. The pipe (28) has, in its running portion, a thin-walled section (50) having a reduced wall thickness less than 1 mm and, at its end (52) nested in the orifice (38), a thick-walled section (50) having an overall wall thickness greater than the reduced thickness.

The present invention relates to an exhaust tract member for a motor vehicle, of the type comprising a wall which delimits an opening for conveying the gases and a pipe for conveying the gases which is fitted in the opening and which is fixedly joined to the periphery of the opening.

Exhaust tracts comprise pipes which constitute channelling conduits for the exhaust gases. Those pipes connect exhaust spaces to each other.

Automotive manufacturers seek to lighten each of the elements of the vehicle in order to reduce fuel consumption and to reduce the cost of the vehicle, by limiting the material used.

Reducing the thickness of the walls of the pipes for conveying the gases encounters the difficulty of connecting the pipe to an exhaust tract element. Welding a pipe having a thin wall in an opening of an exhaust tract element is complex, because of the manufacturing tolerances and the need to use conventional welding and positioning means.

The object of the invention is to provide an exhaust tract member whose weight is reduced and a manufacturing method.

To that end, the invention relates to an exhaust tract member of the above-mentioned type, characterized in that the pipe has, in the flow portion thereof, a thin-walled portion having a reduced wall thickness which is less than 1 mm and, at the end thereof fitted in the opening, a thick-walled portion having a total wall thickness greater than that reduced thickness.

In accordance with specific embodiments, the exhaust tract member comprises one or more of the following features:
the pipe comprises a thin-walled tube having that reduced wall thickness and a separate sleeve which is engaged inside the thin-walled tube at the end thereof fitted in the opening; and
the pipe comprises a thin-walled tube having that reduced wall thickness and a separate sleeve which is engaged around the thin-walled tube at the end thereof fitted in the opening;
the pipe comprises, over most of its length, a thin-walled portion which is extended by a thick-walled portion which is arranged at the end fitted in the opening, the thin-walled portion and the thick-walled portion being integral;
the pipe comprises a thin-walled tube having that reduced wall thickness and a sleeve which is attached as an extension of the thin-walled tube and which is connected thereto by means of welding;
the pipe comprises a thin-walled tube which generally has the reduced wall thickness and, at the end thereof fitted in the opening, the tube has double the thickness which is formed by the wall of the tube turned over on itself;
the exhaust tract element comprises a cylindrical portion which delimits the opening, the end of the pipe being fitted in the cylindrical portion, and the total wall thickness of the cylindrical portion is greater than the reduced wall thickness of the thin-walled portion of the pipe;
the difference between the total wall thickness of the thick-walled portion which extends to the end of the pipe and the reduced thickness of the thin-walled portion of the pipe is from 0.1 to 0.5 mm;
the ratio of the total wall thickness of the thick-walled portion which extends to the end of the pipe relative to the reduced thickness of the thin-walled portion of the pipe is from 1.1 to 2;
the total wall thickness of the thick-walled portion which extends to the end of the pipe is from 0.35 to 1.4 mm; and
the substantially constant diameter of the pipe is from 30 mm to 80 mm.

The invention also relates to a method for manufacturing an exhaust tract member comprising:
an exhaust tract element comprising a wall which delimits an opening for conveying the gases;
a pipe for conveying the gases which is fitted in the opening and which is retained by being welded to the periphery of the opening,
   characterized in that it comprises the steps of:
forming a pipe having, in the flow portion thereof, a thin-walled portion having a reduced wall thickness which is less than 1 mm and, at the end thereof fitted in the opening, a thick-walled portion having a total wall thickness greater than that reduced thickness;
fitting the thick-walled portion in the opening; and
fixedly joining the thick-walled portion to the periphery of the opening.

Finally, the invention relates to the use for fixedly joining an exhaust pipe having a substantially constant diameter over its length to the periphery of an opening of an exhaust tract element, the pipe comprising, over at least a portion of its length, a thin-walled portion having a first wall thickness, a pipe whose end that is engaged in the opening is formed by a thick-walled portion having a second thickness, that second thickness being greater than that first thickness.

The invention will be better understood from a reading of the following description given purely by way of example and with reference to the drawings, in which:

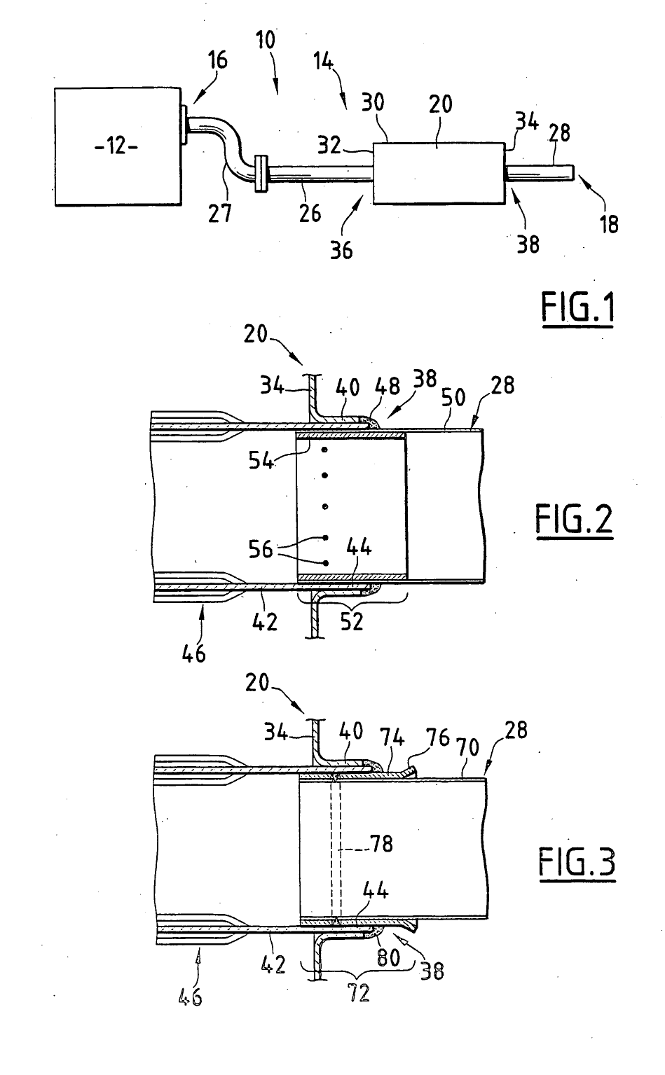

FIG. 1 is a schematic view of an exhaust tract comprising an exhaust tract member according to the invention;

FIGS. 2, 3, 4, 5 and 6 are longitudinal sections of the connection between an element of the exhaust tract of FIG. 1 and a gas circulation pipe.

FIG. 1 illustrates the propulsion installation 10 of a motor vehicle. That installation comprises a thermal engine 12, such as a diesel engine, or a petrol engine, and an exhaust tract 14 according to the invention.

The exhaust tract 14 comprises an end 16 for connection to the engine 12 and an end 18 for releasing the exhaust gases into the atmosphere.

Between those two ends, the tract 14 comprises an exhaust space 20.

The space 20 constitutes, for example, an exhaust silencer having internally a plurality of chambers which are connected to each other by a convoluted path in order to ensure a reduction in noise pollution brought about by the release of the exhaust gases into the atmosphere and their conveyance in the tract.

The space 20 is connected to the inlet 16 of the tract by a rectilinear inlet pipe 26 which is connected to an intake pipe 27. The exhaust outlet 18 is formed at the end of a rectilinear outlet pipe 28.

The pipes 26, 28 have, in their flow portion, that is to say, outside the connection ends, thin-walled portions having a reduced wall thickness of less than 1 mm. That reduced thickness is preferably from 0.5 to 1 mm for pipes having a diameter of from 30 mm to 80 mm.

The pipes 26 and 28 have, at their ends for connection to the exhaust space, a thick-walled portion whose total wall thickness is greater than the reduced thickness of the flow portion of the pipe.

The exhaust space 20 has a cylindrical side wall 30 which is closed at each end by a transverse wall 32, 34, also referred to as a cap.

Those end walls have openings 36, 38 for the circulation of the gases, to which the pipes 26 and 28 are connected.

FIG. 2 illustrates a first embodiment of the connection between the space 20 and the pipe 28.

As illustrated in this Figure, the transverse wall 34 has an outer collar 40 which borders the opening 38. The collar is fixedly joined to the transverse wall 34 and constitutes a barrel-type drawing. The thickness of the collar 40 is, for example, from 0.5 to 1.2 mm.

The space 20 further comprises an inner tube 42 for channelling the gases into the space. That tube 42 has its end 44 engaged axially through the collar 40. The tube 42 has passages 46 for the flow of the gases into the exhaust space.

The wall thickness of the tube 42 is from 0.5 to 1.2 mm. In this manner, the pipe 28 is fitted and connected to a cylindrical conduit whose total wall thickness is greater than the thickness of the pipe in the flow portion thereof. The total wall thickness is, in practice, from 1 to 2.4 mm.

The connection between the pipe 28 and the periphery of the opening 38 is brought about by a weld bead 48 which is formed around the thick-walled portion. The weld bead is obtained by a welding method of the MIG (Metal Inert Gas) or MAG (Metal Active Gas) type.

In the embodiment of FIG. 2, the pipe 28 comprises a thin-walled tube 50 whose wall thickness is reduced and is in particular less than 1 mm.

The end designated 52 of the tube 50 is fitted in the opening 38. At its end 52, the tube has internally a separate sleeve 54. The sleeve 54 has a wall thickness of from 0.5 to 1.2 mm, its length being from 10 to 70 mm. The length of the sleeve is suitable for it to extend over the entire length of the portion of the tube 50 fitted in the opening 38.

The sleeve 54 is connected to the tube 50 by a resistance welding method, bringing about a plurality of spot welds 56 which are distributed over the periphery of the sleeve. The welding operation is carried out before the tube 50 containing the sleeve 54 is introduced into the opening 38.

In order to fixedly join the assembly together, the tube 50 which is provided with the sleeve 54 beforehand is introduced into the opening 38 and the peripheral weld bead 48 is formed at the end of the collar 40, at the end 44 of the tube 42 and at the outer surface of the tube 50 around the end portion 52 containing the sleeve 54.

FIGS. 3 to 6 illustrate other methods for fixing a pipe whose flow portion has a thin wall to the exhaust space 20. In these Figures, identical elements are referred to using the same reference numerals.

In the embodiment of FIG. 3, the pipe 28 comprises a thin-walled tube 70 whose wall thickness is less than 1 mm. An outer sleeve 74 is attached around the connection end 72 thereof. That sleeve has a length of from 10 to 70 mm and a thickness of from 0.5 to 1.2 mm.

The sleeve 74 has, at its end directed towards the flow portion of the tube 70, a flared portion 76 which facilitates the insertion of the tube 70 into the sleeve 74.

In order to manufacture such an assembly, the sleeve 74 is engaged around the tube 70 at its end 72 which has to be engaged in the opening 38. The sleeve 74 is narrowed onto the tube 70 then is welded thereto, for example, by resistance welding. Advantageously, the welding is carried out by means of a wheel which travels on the periphery of the sleeve so that a continuous weld bead 78 is obtained between the tube 70 and the sleeve 74. As a variant, the tube 70 is expanded onto the sleeve 74.

The tube 70 which is provided with the sleeve 74 in this manner is then introduced into the opening 38. A common peripheral weld 80 is brought about at the end of the tube 44 in order to ensure simultaneous connection of the collar 40, the end 44 of the tube and the sleeve 74.

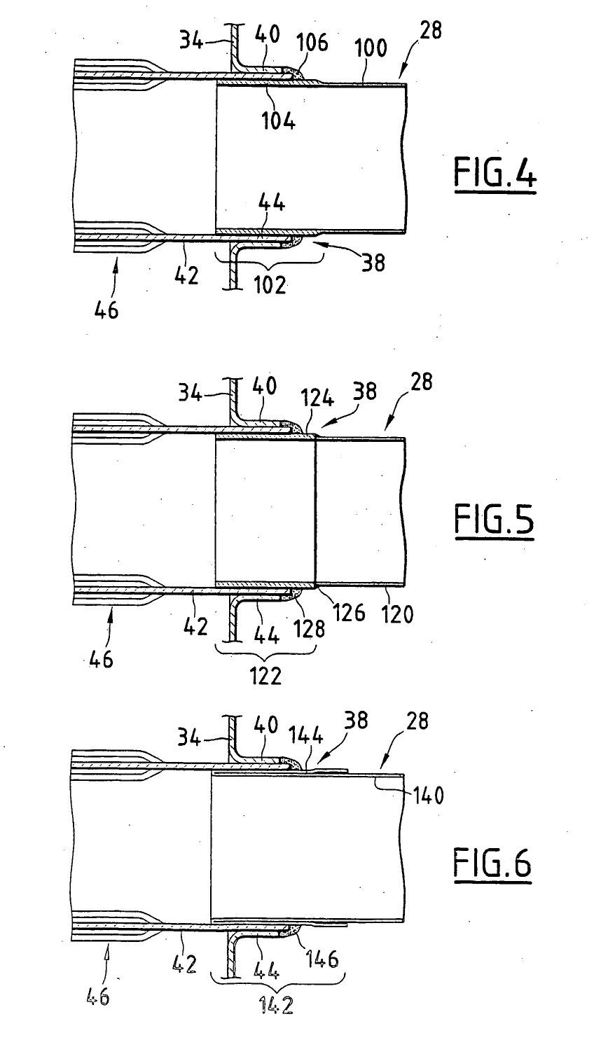

In the embodiment of FIG. 4, the pipe 28 comprises a thin-walled portion 100 which extends over most of its length. The wall thickness over that thin-walled portion 100 is less than 1 mm. At the end 102 thereof that is engaged in the opening 38, the pipe 28 has a thick-walled portion 104 whose wall thickness is greater than that of the thin-walled portion. The wall thickness is, for example, 1.2 mm. It is preferably from 110% to 200% of the thickness of the wall of the thin-walled portion.

Preferably, the total wall thickness of the thick-walled portion is from 0.1 to 0.5 mm greater than the wall thickness of the thin-walled portion.

The pipe 28 is formed by an extrusion method starting from a tube whose initial wall thickness is equal to the wall thickness of the thick-walled portion. In the flow portion thereof, the tube is narrowed by the extrusion method, as is known per se. In this manner, the thin-walled portions and thick-walled portions are integral with each other.

The thick-walled portion 104 is fitted in the opening 38. The collar 40, the end 44 of the inner tube and the pipe 28 are connected together by a weld bead 106 which is arranged around the thick-walled portion 104.

In the embodiment of FIG. 5, the pipe 28 comprises, in its flow portion, a thin-walled tube 120. An axial sleeve 124, whose wall thickness is greater than that of the thin-walled tube 120, is attached at the end 122 thereof that is engaged in the opening 38. The sleeve 124 has a wall thickness of from 0.35 to 1.4 mm, whilst having a wall thickness which is from 10 to 100% greater than the wall thickness of the thin-walled tube 120.

The sleeve 124 adjoins the end of the tube 120, the end-to-end connection being brought about, for example, by a laser welding method without any metal being added, before the sleeve 124 is inserted into the opening 38. A weld 126 is formed in this manner. The connection between the pipe 28 and the exhaust tract element 20 is brought about by a peripheral weld bead 138 which is formed around the sleeve 124 at the free ends of the tube 42 and the collar 40.

In the embodiment of FIG. 6, the pipe 28 is constituted by a thin-walled tube 140 whose end 142 is turned over outwards in order to form, by inversion or invagination, an outer skirt 144 which presses on the flow portion of the tube 140. Thus, the end portion 142 has a double thickness. That portion 146 having double thickness is engaged in the opening 38 and is welded to the ends of the collar 40 and the tube 42 by a weld bead 146. In a variant, the turning-over of the end 42 is inwards and not outwards.

It will be appreciated that since, in all the embodiments, the end of the pipe 28 has an additional thickness relative to the flow portion thereof, the welding produced between the exhaust tract element and the pipe is carried out satisfactorily around the portion that is fitted in the opening 38, whose thickness is adequate.

Thus, the element of the exhaust tract is lightened, whilst retaining a satisfactory level of mechanical strength of the assembly.

The proportions between the thicknesses of the thin and thick walls given by way of example can be applied to all the embodiments.

1. Exhaust tract member comprising:
an element (20) of an exhaust tract comprising a wall which delimits an opening (38) for conveying the gases; and
a pipe (28) for conveying the gases which is fitted in the opening (38) and which is fixedly joined to the periphery of the opening (38),
characterized in that the pipe (28) has, in the flow portion thereof, a thin-walled portion (50; 70; 100; 120; 140) having a reduced wall thickness which is less than 1 mm and, at the end thereof (52; 72; 102; 122; 142) fitted in the opening (38), a thick-walled portion (50; 54; 70, 74; 104; 124; 144; 146) having a total wall thickness greater than that reduced thickness.

2. Exhaust tract member according to claim 1, characterized in that the pipe (28) comprises a thin-walled tube (50) having that reduced wall thickness and a separate sleeve (54) which is engaged inside the thin-walled tube (50) at the end (52) thereof fitted in that opening (38).

3. Exhaust tract member according to claim 1, characterized in that the pipe (28) comprises a thin-walled tube (70) having that reduced wall thickness and a separate sleeve (74) which is engaged around the thin-walled tube (70) at the end (72) thereof fitted in the opening (38).

4. Exhaust tract member according to claim 1, characterized in that the pipe (28) comprises, over most of its length, a thin-walled portion (100) which is extended by a thick-walled portion (104) which is arranged at the end fitted in the opening (38), the thin-walled portion (100) and the thick-walled portion (102) being integral.

5. Exhaust tract member according to claim 1, characterized in that the pipe (28) comprises a thin-walled tube (120) having that reduced wall thickness and a sleeve (124) which is attached as an extension of the thin-walled tube (120) and which is connected thereto by means of welding.

6. Exhaust tract member according to claim 1, characterized in that the pipe (28) comprises a thin-walled tube (140) which generally has the reduced wall thickness, and in that, at the end thereof fitted in the opening (38), the tube (140) has double the thickness (140, 144) which is formed by the wall of the tube turned over on itself.

7. Exhaust tract member according to claim 1, characterized in that the exhaust tract element (20) comprises a cylindrical portion (40, 44) which delimits the opening (38), the end of the pipe being fitted in the cylindrical portion (40, 44), and in that the total wall thickness of the cylindrical portion is greater than the reduced wall thickness of the thin-walled portion of the pipe (28).

8. Exhaust tract member according to claim 1, characterized in that the difference between the total wall thickness of the thick-walled portion (50, 54; 70, 74; 104; 124; 144, 146) which extends to the end of the pipe (28) and the reduced thickness of the thin-walled portion (50; 70; 100; 120; 140) of the pipe (28) is from 0.1 to 0.5 mm.

9. Exhaust tract member according to claim 1, characterized in that the ratio of the total wall thickness of the thick-walled portion (50, 54; 70, 74; 104; 124; 144, 146) which extends to the end of the pipe (28) relative to the reduced thickness of the thin-walled portion (50; 70; 100; 120; 140) of the pipe (28) is from 1.1 to 2.

10. Exhaust tract member according to claim 1, characterized in that the total wall thickness of the thick-walled portion (50, 54; 70, 74; 104; 124; 144, 146) which extends to the end of the pipe (28) is from 0.35 mm to 1.4 mm.

11. Exhaust tract member according to claim 1, characterized in that the substantially constant diameter of the pipe (28) is from 30 mm to 80 mm.

12. Method for manufacturing an exhaust tract member comprising:
an exhaust tract element (20) comprising a wall which delimits an opening (38) for conveying the gases;
a pipe (28) for conveying the gases which is fitted in the opening (38) and which is retained by being welded to the periphery of the opening (38),
characterized in that it comprises the steps of:
forming a pipe (28) having, in the flow portion thereof, a thin-walled portion (50; 70; 100; 120; 140) having a reduced wall thickness which is less than 1 mm and, at the end (52; 72; 102; 122; 142) thereof fitted in the opening (38), a thick-walled portion (50, 54; 70, 74; 104; 124; 144, 146) having a total wall thickness greater than that reduced thickness;
fitting the thick-walled portion (50, 54; 70, 74; 104; 124; 144, 146) in the opening (38); and
fixedly joining the thick-walled portion (50, 54; 70, 74; 104; 124; 144, 146) to the periphery of the opening (38).

13. Use for fixedly joining an exhaust pipe having a substantially constant diameter over its length to the periphery of an opening (38) of an element (20) of an exhaust tract, the pipe comprising, over at least a portion of its length, a thin-walled portion having a first wall thickness, a pipe whose end (52; 72; 102; 122; 142) that is engaged in the opening (38) is formed by a thick-walled portion (50, 54; 70, 74; 104; 124; 144, 146) having a second thickness, that second thickness being greater than that first thickness.
